(19) United States
(12) Patent Application Publication
(10) Pub. No.: US 2019/0075836 A1
(43) Pub. Date: Mar. 14, 2019

(54) SYSTEM AND METHOD FOR THE PRESERVATION OF COCONUT PRODUCTS

(71) Applicant: Premium Costa Rica Products LLC, Austin, TX (US)

(72) Inventors: Dwight Hartley, Stephenville, TX (US); Curtis Brooks, San Jose (CR)

(73) Assignee: Premium Costa Rica Products LLC, Austin, TX (US)

(21) Appl. No.: 15/704,988

(22) Filed: Sep. 14, 2017

(51) Int. Cl. A23N 12/02; A23L 3/3454; A23L 3/36; A23L 19/00

(52) U.S. Cl. CPC A23N 12/02; A23L 3/3454; A23V 2002/00; A23L 19/03; A23L 3/36

(57) ABSTRACT

A system and method for the preservation of coconut products via dehydration and freezing are disclosed. Via the systems and methods described herein, coconuts can achieve a significantly longer shelf life, without degradation of the coconuts naturally-occurring beneficial aspects. One exemplary embodiment of the invention discloses a method for the preservation of a coconut by dehydrating the coconut in a blast cooler with a dehumidifier and a blower. The combination of the cool temperature and the dry airflow over the coconut, cause the coconut to dehydrate, decreasing the amount of water inside the coconut. With less water inside of the coconut, the coconut can then be frozen in a shock freezer, without cracking the coconut. The coconut is then defrosted at a specific temperature for a specific period of time, to ensure the coconut shell remains dry, thereby preventing mold and mildew on the exterior of the coconut.

### BACKGROUND OF THE INVENTION

### 1. Field of the Invention

The present invention is generally related to produce preservation systems and methods, and more specifically to systems and methods for the preservation of coconut products via dehydration and freezing.

### 2. Background of the Invention

Coconut water has been long known to contain beneficial aspects. However, many of these health aspects can be lost by modern attempts to preserve and store the coconuts. Coconut products have the highest potency when consumed in their natural state. As an example, in the Pacific Theater during World War II, during an emergency, medics were known to intravenously administer coconut water to soldiers in need as a plasma replacement when their plasma supplies ran out. Often times, coconuts were picked from the trees and tapped within minutes of harvest to maintain the beneficial traits. These beneficial traits would be degraded by the pasteurization process or the addition of preservatives.

Perhaps the largest problem with the coconut is its notoriously short shelf life. Most coconuts have approximately a 14-day shelf life before the coconut begins to rot. As the coconut gets older and older, the oils begin to take over. The coconut water in younger coconuts has a sweeter taste profile, as the sugars in the water have yet to be absorbed by the coconut meat. The problem presented then is how to provide coconut water in its natural state without heat pasteurization that destroys electrolytes, so that the pure form gets to the customer. Pasteurizing affects the oils and kills the enzymes, and changes the sugar profile by effectively caramelizing the sugars. Coconuts are seasonal, so they can only be purchased during a small time window. Previous approaches to preserving coconuts include the administration of preservatives to the coconuts, or when the coconut water is bottled.

Standard freezing approaches do not work because the coconut is a sealed container. Therefore, when this sealed container is frozen, it cracks due to the expansion of the water in the coconut. This also exposes the coconut products to the oxygen in the air, thereby initiating the degradation process. Another approach is to flash freeze the water immediately upon removal from the coconut. However, this freezing of the coconut water outside of its natural environment, affects the flavor profile, as the sugars have not yet enhanced the flavor of the water. Maintaining the electrolytes in their natural form can also provide health benefits. The smallest coconuts can contain about 225 ml of water, with the largest coconuts containing 500 ml or more of water.

### SUMMARY OF THE INVENTION

The present invention achieves technical advantages as a system and method for the preservation of coconut products via dehydration and freezing. Via the systems and methods described herein, coconuts can achieve a significantly longer shelf life, without degradation of the coconuts naturally-occurring beneficial aspects. One exemplary embodiment of the invention discloses a method for the preservation of a coconut by first disinfecting one or more coconuts using a suitable disinfectant, such as an organic acid. The coconut is then weighed to determine an initial weight. After which, the coconut is loaded onto shelves into a blast cooler, where it is chilled. The blast cooler is dehumidified with a dehumidifier. One or more blowers generate an airflow in the blast cooler. The combination of the cool temperature and the dry airflow over the coconut, cause the coconut to dehydrate, thereby decreasing the amount of water inside the coconut. This dehydration is continued until a target coconut weight loss is achieved. An oil can be applied to the coconut after the target weight loss is achieved to stop the dehydration process. With less water inside of the coconut, the coconut can then be frozen in a shock freezer, without cracking the coconut. The coconut is then defrosted at a specific temperature for a specific period of time, to ensure the coconut shell remains dry, thereby preventing mold and mildew on the exterior of the coconut.

Other embodiments in accordance with the spirit and scope of the invention will become apparent to those of skill in the art.

### BRIEF DESCRIPTION OF THE DRAWINGS

FIG. 1 is a block diagram of a coconut product preservation system, in accordance with an embodiment of the claimed invention;

FIG. 2 is a block diagram of a method for the preservation of coconut products, in accordance with an embodiment of the claimed invention; and

FIG. 3 is a block diagram of a method for the preservation of coconut products, in accordance with another embodiment of the present invention.

### DETAILED DESCRIPTION OF THE INVENTION

The preferred version of the invention presented in the following written description and the various features and advantageous details thereof are explained more fully with reference to the non-limiting examples included in the accompanying drawings and as detailed in the description which follows. Descriptions of well-known components and processes and manufacturing techniques are omitted so as to not unnecessarily obscure the principle features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

### Point of Harvest

The proper point of harvest occurs 7 to 8 months from the moment the coconut tree's flower opens for pollination. The color of a properly ripe coconut will be a bit duller than that of a coconut not yet ready for harvest, which will have a shinier exterior and will also be rounder in shape. A properly ripe coconut will be less round than its unripe counterpart. A coconut past its ideal point of ripeness will be soft at the pressing of the fingers against the husk of the coconut. Timing is important in that rain, humidity, and temperature can shift the prime harvest point by a week or more.

### Harvesting the Coconut

Again timing is important and the harvested coconut must be quickly processed and each step must be done with speed to maintain the freshness. The harvested coconut has to be kept in the shade and transported to the processing plant within six hours of harvest. The harvest is conducted using a ladder, a rope, a hook, and a 12″-14″ hand saw. Each harvester safely places the ladder against the coconut tree, climbs it, secures the ladder to the tree by way of tying a rope at the top around the tree, identifies the coconuts ready for harvest and directs the rope (with a hook at the tip) around the back of the leaf immediately adjacent to the bunch that will be harvested, secures the hook to the interior of the bunch, cuts with the saw, and then lowers the bunch down to the ground holding the side of the rope behind the leaf holding the weight, where a carrier, using a wheelbarrow, will collect each bunch and carry it outside the farm for counting and loading on to the truck.

### Washing and Disinfecting the Whole Coconut

Immediately upon receiving, whole coconut bunches and coconuts that have become loose from the coconut bunch disinfected using a suitable disinfectant, such as an organic acid, for example by pouring the coconuts into a potable water solution with 80 ppm of peracetic acid and soaking for at least 2 minutes. This step also includes the use of rollers and brushers to remove excess dirt from coconuts. Each nut must be separated from the bunch for more careful washing. A rollers system with drying trays is used to quickly transport loose coconuts through dryer fans to the next step in the process.

### Grade Assignment

The exterior of the coconut, referred to as the husk, is removed mechanically. Once husked, approximately 25 coconuts are preferably placed in plastic crates. Alternatively, any suitable number may be placed in the crate commensurate with the crate size. Each coconut is then individually weighed to assign each coconut a “grade.” Based on its weight, a coconut is assigned to one of seven different grade categories, which are later used to satisfy customer demand for specific grades. The grade categories can be increased or decreased based on the specific application. During the weighing process, damaged or otherwise unwanted coconuts are discarded.

### Paring the Coconut

The husking of the coconut leaves it with an overly rough appearance. In order to improve the aesthetics for an end consumer, the remaining coconut husk is pared away. Excess long fibers sticking off the coconut are removed and then the coconut is polished on the top and bottom of the coconut for ease of further processing and consumption. The long threads of fiber and bulges on the surface or the coconut are removed to ensure final appearance is rustic but smooth, without looking like a sanded product. All pared coconuts are then reweighed to determine an initial weight after paring to regrade the coconut, as fiber removal can cause a change in grade.

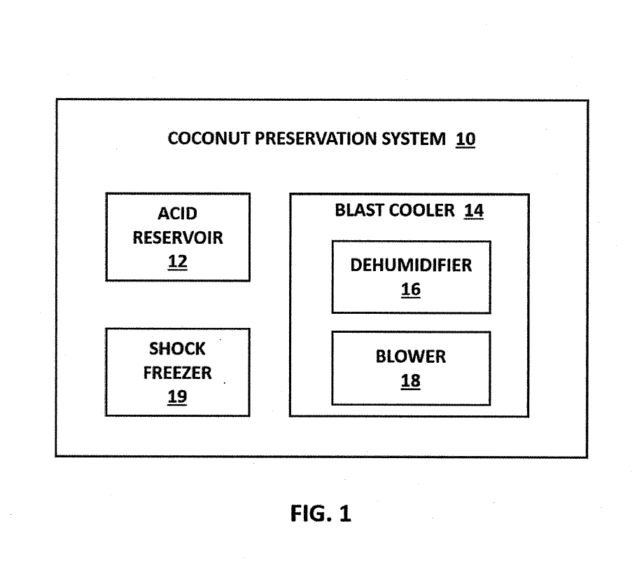

FIG. 1 is a block diagram of a coconut product preservation system, generally designated as 10, in accordance with an embodiment of the claimed invention. The coconut product preservation system 10 is adapted to allow freezing of the coconut without cracking the coconut shell. The coconut product preservation system 10 includes an acid reservoir 12, a blast cooler 14, a dehumidifier 16, a blower 18, and a shock freezer 19.

### Washing and Disinfecting

Once the coconut is pared and labeled, the coconut should be washed and disinfected to remove harmful bacteria and microorganisms. The coconut is washed in potable water and then disinfected in the acid reservoir 12. The acid reservoir 12 can be a basin or other suitable receptacle that contains a disinfecting agent. The acid reservoir 12 preferably contains a peracetic acid solution at 80 ppm. Peracetic acid is widely used as a disinfectant and antimicrobial wash for fruit and vegetables and in other areas of the food industry and makes a convenient disinfectant for the present purpose. Alternatively, any suitable disinfecting agent can be used. Each coconut preferably remains in this solution for two minutes. However, the time duration can be altered based on the disinfecting agent's characteristics. The coconut is then packaged based on grading and market requirements. Each package is then individually weighed and weight marked for assessment after air drying and chilling.

### Air Drying and Chilling

In order to preserve the coconut products (such as the coconut water and coconut meat) of the coconut for storage or shipping and maintain the benefits of the natural coconut products, the coconuts are dehydrated and then frozen. Because the coconut is effectively a fixed space containing a liquid. Simply freezing the coconut would cause the coconut shell to crack as the water inside of the coconut expands. Accordingly, the coconut water must be dehydrated to allow for the expansion. The coconut is preferably placed on a shelf of a rack or roller tray stack, capable of holding at least fifty coconuts. Alternatively, the shelf can be sized to hold more or fewer coconuts, based on other requirements, such as blast cooler size or rack constraints. In another embodiment, the shelf can be a tray that can be inserted into a rack. The coconuts are preferably spaced with at least a 12 millimeter horizontal clearance around the coconut and each shelf is separated by at least a 5 centimeter vertical clearance above the coconut, measured from top of the coconut to the bottom of any shelf above it. The number of shelves can vary based on size of the coconuts and the size of the blast cooler 14. The roller tray stacks are preferably two meters high, but can vary in height based upon the size of the blast cooler 14. The coconut is chilled in the blast cooler 14, which maintains a temperature between 1° C. to 3° C., preferably 2° C.

A dehumidifier 16 is preferably a stand-alone unit placed inside the blast cooler 14. The dehumidifier 16 removes the moisture in the air inside the blast cooler 14. Alternatively, the dehumidifier 16 can be built into the blast cooler 14. The dehumidifier is preferably a desiccant dehumidifier that includes a dry and stable desiccant to remove moisture from the air. The desiccant can be a silica gel, or other suitable material. This dehumidifier 16 allows cold air to be dehumidified without reducing the air temperature, such that the freezing and/or frosting of the coconut is prevented. Importantly, the humidity should be reduced as much as possible, while holding the temperature just above freezing at 1° C. to 3° C.

The coconut product preservation system 10 includes a blower 18, which increases airflow inside of the cooler. The blower 18 is preferably a stand-alone industrial blower that is placed inside the blast cooler 14. Alternatively, the blower 18 can be built into the blast cooler 14. The coconut product preservation system 10 preferably includes two or more blowers 18. The airflow generated by the blower 18 is required to properly dehydrate product prior to freezing. The airflow scrubs the coconut to wick water through the coconut shell and into the air. This allows the coconut product preservation system 10 to produce an even dehydration for each coconut in the blast cooler 14. The coconuts are chilled in the blast cooler 14 for between 164 hours to 169 hours, based on coconut size, or other relevant constraint. The dehydration process is preferably arrested once the coconut achieves a 10% target weight loss. Alternatively, the target weight loss can be varied based upon the size of the coconut. After the passage of requisite time, the coconuts are re-weighed to ensure a 10% weight loss. A control set of coconuts, which have exact weights associated with them can be included in the bath of coconuts to be dehydrated to more accurately pinpoint optimal sweetness and freeze point.

### Dehydration Stoppage

Once a 10% target weight loss is achieved, a food-grade oil is applied to the surface of the coconut and the coconut is allowed to dry in cold storage. Alternatively, the oil can be a mineral oil or super-thin mineral oil. The oil is preferably mixed with water at 20 ppm and sprayed evenly on the coconuts to seal and further stop any dehydration. Alternatively, the oil is mixed with some other suitable delivery mechanism at a suitable ratio for the delivery of the oil onto the coconut. This oil coating seals the coconut such that the coconut's moisture is maintained within the coconut. Advantageously, the oil coating also halts any coconut deterioration and promotes the continued vitality of the coconut, by substantially eliminating any mold or mildew on the exterior of the coconut, thereby increasing the coconut's aesthetic appeal to a consumer.

### Freezing

Once the coconut is dehydrated by 10%, the coconut can be frozen to preserve its beneficial attributes. The coconut is preferably frozen in a shock freezer 19. The shock freezer 19 is preferably set to 100% humidity at a temperature of −25° C. The coconut is preferably frozen in the shock freezer 19 until completely frozen. In one embodiment the coconut is frozen for 10 hours, however the time can vary based upon the size or grade of the coconut. This process prevents further dehydration and maintains the quality of the water at its pre-frozen state. Advantageously, the coconut products have not been exposed to oxygen, which degrades the beneficial attributes, such as flavor and color. The frozen coconut is then boxed and loaded onto a temperature-controlled container, maintained below freezing, which is dispatched for shipment to multiple markets in multiple geographic locations. The shock freezer 19 is used because the freezing process occurs so rapidly that no ice crystals have had time to form, as the ice crystals can diminish the flavor profile of the coconut water.

### Thawing

Once the coconut reaches its desired destination, the coconut can be thawed (also known as “slacking out”) for retail sale or consumption. The coconut is preferably kept between a temperature range of −20° C. to −25° C., until defrosted. In one embodiment, this defrosting or slacking process requires that the product be moved to a refrigerated area with a constant temperature of 3.5° C. to 5° C., for a period of 48 hours. These steps will effectively maintain the coconut shell in a dry condition, which prevents the shell from molding.

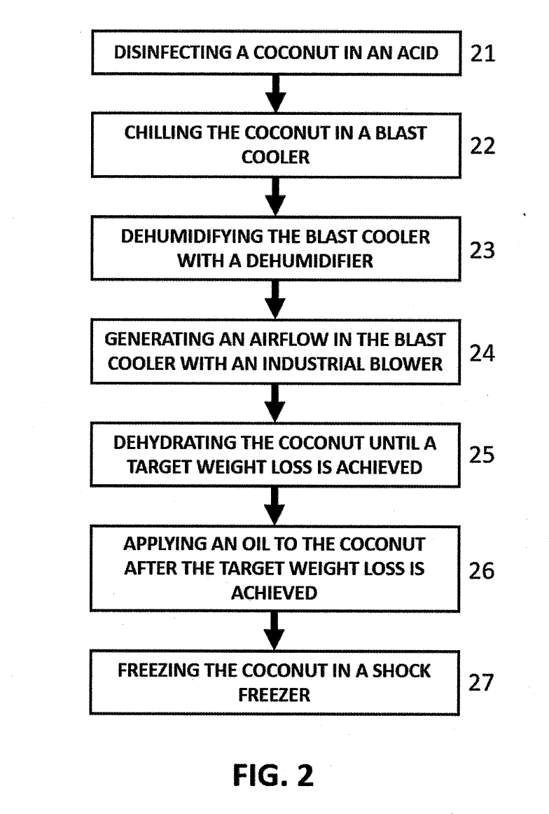

Referring now to FIG. 2, there is shown a block diagram of a method for the preservation of coconut products, in accordance with an embodiment of the claimed invention. The method begins at step 21 where a coconut is disinfected in an acid. In one embodiment, the coconut is disinfected in a peracetic acid solution at 80 ppm. Alternatively, any suitable acid and ratio can be used. The method then proceeds to step 22. At step 22, the coconut is chilled in a blast cooler. In one embodiment, the coconuts are chilled in the blast cooler, which maintains a temperature between 1° C. to 3° C., preferably 2° C. The method then proceeds to step 23.

At step 23, the blast cooler is dehumidified with a dehumidifier. The dehumidifier is a stand-alone unit placed inside the blast cooler. The dehumidifier removes the moisture in the air inside the blast cooler. Alternatively, the dehumidifier can be built into the blast cooler. The method then proceeds to step 24. At step 24, an airflow is generated in the blast cooler with an industrial blower. The blower is preferably a stand-alone industrial blower that is placed inside the blast cooler. Alternatively, the blower can be built into the blast cooler. The method then proceeds to step 25.

At step 25, the coconut is dehydrated until a target weight loss is achieved. The airflow generated by the blower is required to properly dehydrate product prior to freezing. The airflow scrubs the coconut to wick water through the coconut shell and into the air. The dehydration process is preferably arrested once the coconut achieves a 10% target weight loss. Alternatively, the target weight loss can be varied based upon the size of the coconut. The method then proceeds to step 26. At step 26, an oil is applied to the coconut after the target weight loss is achieved. Once a 10% target weight loss is achieved, a food-grade oil is applied to the surface of the coconut and the coconut is allowed to dry in cold storage. Alternatively, the oil can be a mineral oil or super-thin mineral oil. The oil is preferably mixed with water at 20 ppm and sprayed evenly on the coconuts to seal and further stop any dehydration. The method then proceeds to step 27.

At step 27, the coconut is frozen in a shock freezer. The shock freezer is preferably set to 100% humidity at a temperature of −25° C. The coconut is preferably frozen in the shock freezer until completely frozen. In one embodiment the coconut is frozen for 10 hours, however the time can vary based upon the size or grade of the coconut. This process prevents further dehydration and maintains the quality of the water at its pre-frozen state.

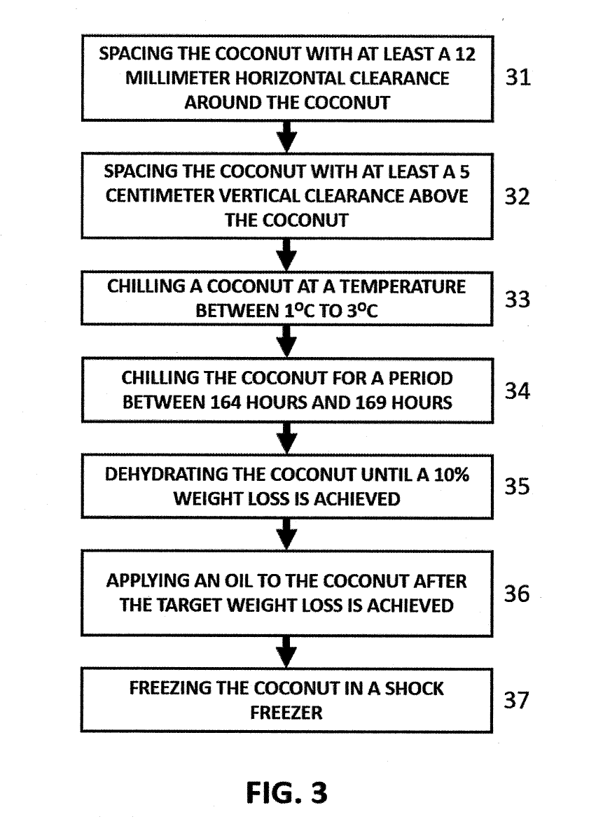

Referring now to FIG. 3, there is shown a block diagram of a method for the preservation of coconut products, in accordance with another embodiment of the claimed invention. The method begins at step 31, where the coconut is spaced with at least a twelve millimeter horizontal clearance around the coconut. The method then proceeds to step 32.

At step 32, the coconut is spaced with at least a five centimeter vertical clearance above the coconut. The method then proceeds to step 33. At step 33, the coconut is chilled at a temperature between 1° C. to 3° C. The coconut is preferably chilled at 2° C. The method then proceeds to step 34.

At step 34, the coconut is chilled for a period between 164 hours and 169 hours. The coconuts are chilled in the blast cooler, based on coconut size, or other relevant constraint. The method then proceeds to step 35. At step 35, the coconut is dehydrated until a 10% weight loss is achieved. The dehydration process is preferably arrested once the coconut achieves a 10% target weight loss. Alternatively, the target weight loss can be varied based upon the size of the coconut. The method then proceeds to step 36.

At step 36, an oil is applied to the coconut after the target weight loss is achieved. Once a 10% target weight loss is achieved, a food-grade oil is applied to the surface of the coconut and the coconut is allowed to dry in cold storage. Alternatively, the oil can be a mineral oil or super-thin mineral oil. The oil is preferably mixed with water at 20 ppm and sprayed evenly on the coconuts to seal and further stop any dehydration. Alternatively, the oil is mixed with some other suitable delivery mechanism at a suitable ratio for the delivery of the oil onto the coconut. The method then proceeds to step 37. At step 37, the coconut is frozen in a shock freezer. The shock freezer is preferably set to 100% humidity at a temperature of −25° C. The coconut is preferably frozen in the shock freezer until completely frozen. In one embodiment the coconut is frozen for 10 hours, however the time can vary based upon the size or grade of the coconut. This process prevents further dehydration and maintains the quality of the water at its pre-frozen state.

Embodiments of the invention may provide numerous advantages. An advantage of one embodiment is the maintenance of purity of the coconut water, such that electrolytes and other beneficial aspects (such as flavor and color) are maintained in their pure form. Exposure of the coconut water to oxygen changes the water color to a pink color. The present invention keeps the coconut products unoxidized and untouched by human hands until the user punctures the shell and consumes the coconut products. Therefore, the enzymes are in their natural state, the sugars have not been affected, and the fats have not gone rancid.

Another advantage of one embodiment is that, due to the increased in shelf life of up to six months, coconuts can be stored for sale during non-seasonal periods.

Another advantage of one embodiment is that the flavor of the coconut water is enhanced. When the coconut water is condensed it makes the water becomes sweeter. As coconut meat freezes, it somewhat releases from the shell which releases sugar back into the remaining water in the coconut.

Another advantage of one embodiment is that the present invention opens the door to those that do not live in the tropics to the beneficial aspects of fresh, unprocessed coconut products.

While the present invention has been described in detail, it is not intended to be limited. Accordingly, various changes, variations, and substitutions may be made without departing with the scope of the invention as disclosed.

What is claimed is:

1. A method for the preservation of a coconut, comprising:
first, disinfecting a coconut using a suitable disinfectant wash or bath;
next, simultaneously chilling, dehumidifying and dehydrating the coconut by placing the coconut in a blast cooler and chilling the coconut without freezing while generating a predetermined airflow in the blast cooler from a suitable air source, the blast cooler also having an associated dehumidifier element incorporated therein, the simultaneous steps of chilling, dehumidifying and dehydrating being continued until a target weight loss is achieved for the coconut;
thereafter, applying an oil to the coconut after the target weight loss is achieved; and
freezing the coconut as a final step.

2. The method of claim 1, wherein the acid is a paracetic acid, diluted to 80 parts-per-million.

3. The method of claim 1, wherein the coconut is chilled in the blast cooler for 164 to 169 hours.

4. The method of claim 1, further comprising spacing the coconut with at least a 13 millimeter horizontal clearance around the coconut.

5. The method of claim 1, further comprising spacing the coconut with at least a 5 centimeter vertical clearance above the coconut.

6. The method of claim 1, wherein the target weight loss is 10% of the coconut's weight.

7. The method of claim 1, wherein the application of the oil to the coconut, protects against dehydration.

8. A coconut preservation system, comprising:
an acid reservoir, having an acid solution, wherein a coconut is immersed in the acid for disinfection;
a blast cooler, wherein the cooler chills the disinfected coconut;
a desiccant dehumidifier disposed within the cooler, wherein the dehumidifier dehumidifies the cooler;
an industrial blower disposed within the cooler, wherein the blower generates an airflow in the cooler; and
a shock freezer, wherein the coconut is frozen.

9. The system of claim 8, wherein the acid solution is a paracetic acid, diluted to 80 parts-per-million.

10. The system of claim 8, wherein the disinfected coconut is chilled in the blast cooler for 164 to 169 hours.

11. The system of claim 8, wherein the disinfected coconut is placed in the blast cooler with at least a 13 millimeter horizontal clearance around the coconut.

12. The system of claim 8, wherein the disinfected coconut is placed in the blast cooler with at least a 13 millimeter horizontal clearance around the coconut.

13. The system of claim 8, wherein the dehumidifier and the blower dehydrate the disinfected coconut.

14. The system of claim 14, wherein the disinfected coconut is dehydrated to a target weight that is 10% of the coconut's weight.

15. The system of claim 8, wherein the application of the oil to the coconut, protects against dehydration.

16. A method for the preservation of a coconut, comprising:
first, disinfecting a coconut using a suitable disinfectant wash or bath;
next, simultaneously chilling, dehumidifying and dehydrating the coconut by placing the coconut in a blast cooler and chilling the coconut without freezing while generating a predetermined airflow in the blast cooler from a suitable air source, the blast cooler also having an associated dehumidifier element incorporated therein, the simultaneous steps of chilling, dehumidifying and dehydrating being continued until a target weight loss is achieved for the coconut;
thereafter, applying a coating to the coconut after the target weight loss is achieved to prevent further dehydration; and
freezing the coconut as a final step.
